(19) United States
(12) Patent Application Publication
(10) Pub. No.: US 2017/0320078 A1
(43) Pub. Date: Nov. 9, 2017

(54) SPRAYER

(71) Applicant: The Sherwin-Williams Company, Cleveland, OH (US)

(72) Inventors: Terry D. Jordan, Parma, OH (US); James J. Johnson, Akron, OH (US); Mary M. Ilko, Silver Lake, OH (US)

(21) Appl. No.: 15/590,704

(22) Filed: May 9, 2017

Related U.S. Application Data
(60) Provisional application No. 62/333,604, filed on May 9, 2016.
(60) Provisional application No. 62/383,014, filed on Sep. 2, 2016.

(51) Int. Cl. B05B 7/04; B05B 7/12; B65D 83/20; B65D 83/30

(52) U.S. Cl. CPC B05B 7/0425; B65D 83/30; B05B 7/1263; B65D 83/202

(57) ABSTRACT

In accordance with an example embodiment, there is disclosed herein a sprayer operable to dispense fluid from a fluid reservoir, such as a paint reservoir. The sprayer comprises a rechargeable battery pack that can be employed to provide power to a pump. The pump provides air to a nozzle assembly that is mixed with fluid from the fluid reservoir and dispensed via the nozzle assembly. In particular embodiments, the nozzle assembly comprises a disposable tip insert.

### CROSS REFERENCE TO RELATED APPLICATIONS

This application is claims the benefit of U.S. Provisional Application No. 62/333,604, filed May 9, 2016 and U.S. Provisional Application No. 62/383,014 filed on Sep. 2, 2016. The contents of the aforementioned applications are herby incorporated by reference herein.

### TECHNICAL FIELD

The present disclosure relates generally to fluid sprayers, such as portable fluid sprayers.

### BACKGROUND

A fluid sprayer includes a pumping unit for pumping a fluid, such as paint, supplied from a paint source, such as a paint container. In one instance, the pumping unit is driven by an electric motor to supply a flow of pressurized paint to an output nozzle or tip of a spray gun. The output nozzle or tip has a particular shape and size to generate a desired spray pattern.

### BRIEF DESCRIPTION OF THE DRAWINGS

The accompanying drawings incorporated herein and forming a part of the specification illustrate the example embodiments.

FIG. 1 is a perspective view of a sprayer in accordance with an example embodiment.

FIG. 2 is a side view of the sprayer of FIG. 1, the opposite side view being a mirror image.

FIG. 3 is a top view of the sprayer of FIG. 1.

FIG. 4 is a bottom view of the sprayer of FIG. 1.

FIG. 5 is a front view of the sprayer of FIG. 1.

FIG. 6 is a rear view of the sprayer of FIG. 1.

FIG. 7 is a cutaway view of the sprayer of FIG. 1 illustrating a simplified view of the components of the sprayer.

FIG. 8 is a perspective view of a sprayer in accordance with an example embodiment.

FIG. 9 is a side view of the sprayer of FIG. 8, the opposite side view being a mirror image.

FIG. 10 is a top view of the sprayer of FIG. 8.

FIG. 11 is a bottom view of the sprayer of FIG. 8.

FIG. 12 is a front view of the sprayer of FIG. 8.

FIG. 13 is a rear view of the sprayer of FIG. 8.

FIG. 14 is a cutaway view of the sprayer of FIG. 8 illustrating a simplified view of the components of the sprayer.

FIG. 15 is a block diagram illustrating an example of a sprayer in accordance with an example embodiment.

FIG. 16 is a block diagram illustrating an example of a sprayer where pressure is provided to the fluid source by the pump.

FIG. 17 illustrates an example of the nose of the sprayer with a disposable tip insert.

FIG. 18 illustrates an example of a methodology for operating a sprayer.

### OVERVIEW OF EXAMPLE EMBODIMENTS

The following presents a simplified overview of the example embodiments in order to provide a basic understanding of some aspects of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented later.

In accordance with an example embodiment, there is disclosed herein, a sprayer operable to dispense fluid from a fluid reservoir, such as a paint reservoir. The comprises a rechargeable power source, a fluid source, a motor and pump assembly, a nozzle assembly, and an actuation mechanism, such as for example a switch, having a first setting (e.g., “ON”) and a second setting (e.g., “OFF”). The motor and pump assembly are coupled with the rechargeable battery. The nozzle assembly is coupled with the motor and pump assembly and the fluid source. When the actuation mechanism is at the first setting, air is pumped by the motor and pump assembly to the nozzle assembly and fluid is provided by the fluid source to the nozzle assembly without passing through the motor and pump assembly. The fluid is mixed with the air at the nozzle assembly, wherein the mixed air and fluid are dispensed by the assembly.

In accordance with an example embodiment, there is disclosed herein, a method of operating a sprayer, the sprayer comprising a rechargeable power source coupled with a motor and pump assembly, the motor and pump assembly coupled with an actuation mechanism and a nozzle assembly, the nozzle assembly located at a nose section of the sprayer. The method comprises fastening a disposable tip assembly to the nozzle assembly, coupling a disposable fluid source to the nozzle assembly, and activating the actuation mechanism. Activating the actuation mechanism causes fluid to flow from the fluid source to the disposable tip assembly, the motor and pump assembly to provide air to the disposable tip assembly, and a mixture of the air and the fluid to be dispensed from the disposable tip assembly. Fluid from the fluid source flows to the nozzle assembly without passing through the motor and pump assembly.

In accordance with an example embodiment, there is disclosed herein, a kit, comprising a sprayer assembly, a disposable fluid container, a disposable tip insert, and a tube. The sprayer assembly comprises a rechargeable power source, a motor and pump assembly coupled with the rechargeable battery, a nozzle assembly at a nose cone section of the sprayer that is coupled with the motor and pump assembly and the fluid source, and a trigger switch coupled with the motor and pump assembly. The disposable fluid container is configured to be coupled with the sprayer assembly. The disposable tip insert is configured to be threadably fastened to the nozzle assembly. The tube couples the disposable fluid container with the disposable tip insert.

### DESCRIPTION OF EXAMPLE EMBODIMENTS

This description provides examples not intended to limit the scope of the appended claims. The figures generally indicate the features of the examples, where it is understood and appreciated that like reference numerals are used to refer to like elements. Reference in the specification to “one embodiment” or “an embodiment” or “an example embodiment” means that a particular feature, structure, or characteristic described is included in at least one embodiment described herein and does not imply that the feature, structure, or characteristic is present in all embodiments described herein.

Described in an example embodiment herein is a portable, hand-held sprayer. The sprayer comprises a rechargeable power source, such as a battery pack, coupled with a motor and pump assembly. At the nose of the sprayer is a nozzle assembly that comprises a disposable tip insert. A fluid source, such as paint is coupled to the nozzle assembly. Upon activation, fluid from the fluid source is provided to the nozzle assembly and air from the motor and pump assembly are also provided to the nozzle assembly. The air and fluid are mixed and dispensed via the disposable tip insert.

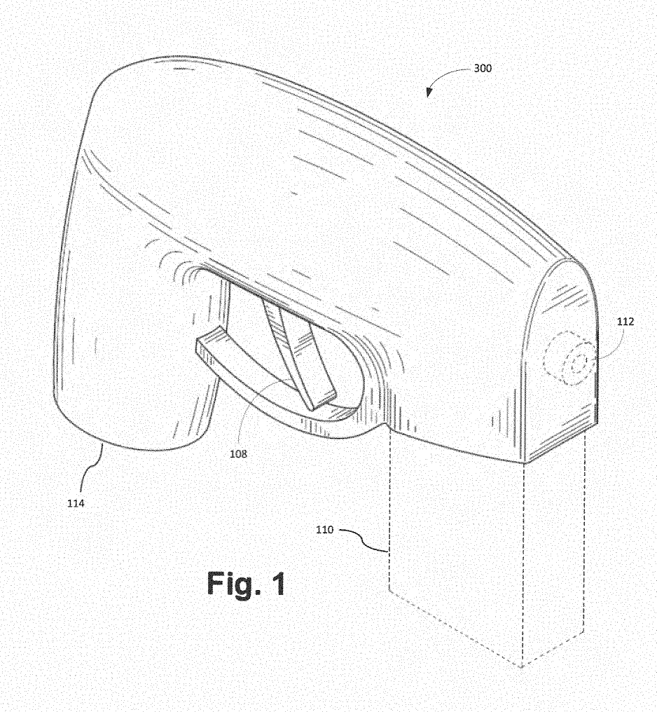

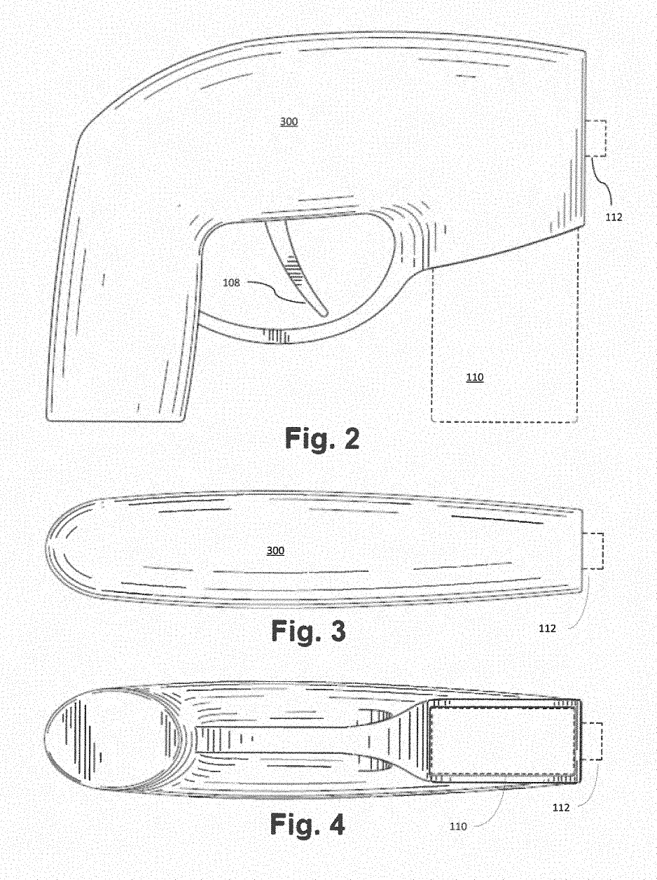

Referring to FIGS. 1-7, there is illustrated an example of a sprayer 300 in accordance with an example embodiment. The sprayer 300 comprises a power source 102, a motor and pump assembly 104, a nozzle assembly 106, an activation mechanism (trigger) 108, a fluid source (e.g., paint reservoir) 110, and a disposable tip insert 112. In the example illustrated in FIGS. 1-7, the power source (battery) 102 is located in a grip section 114 at the rear of the sprayer 300, and the paint reservoir 110 is located at the front of sprayer 300.

The power source 102 is coupled with the motor and pump assembly 104. The motor and pump assembly is coupled with the tip insert 112 in nozzle assembly 106. In particular embodiments, an air valve is disposed between the motor and air pump assembly 104, and fluid source 110 and the tip insert 112. The fluid source 110 and motor and pump assembly are coupled with the tip insert 112 nozzle assembly 106. In the illustrated example, the actuation mechanism (trigger) 108 is coupled with the motor and pump assembly 104 and the fluid source 110. Those skilled in the art should readily appreciate that the arrangement of the components 102, 104, 106, 108, 110, 112 for the sprayer 300 was selected merely for ease of illustration and that the components 102, 104, 106, 108, 110, 112 for the sprayer 300 may be arranged in any desirable configuration.

The power 102 source may be any suitable power source, including but not limited to a coupling for an external power source, a battery and a rechargeable battery. The power source 102 may provide any desired voltage and/or current. In an example embodiment, the power source 102 comprises a rechargeable battery pack that is capable of providing power enabling the sprayer 300 to be able to run continuously for up 30 minutes on a single charge.

In an example embodiment, the motor and pump assembly comprises a Direct Current (“DC”) motor that operates the pump. The pump is capable of delivering up to 25 (pounds per square inch (“psi”) and 0.5 standard cubic feet per hour (“scfh”).

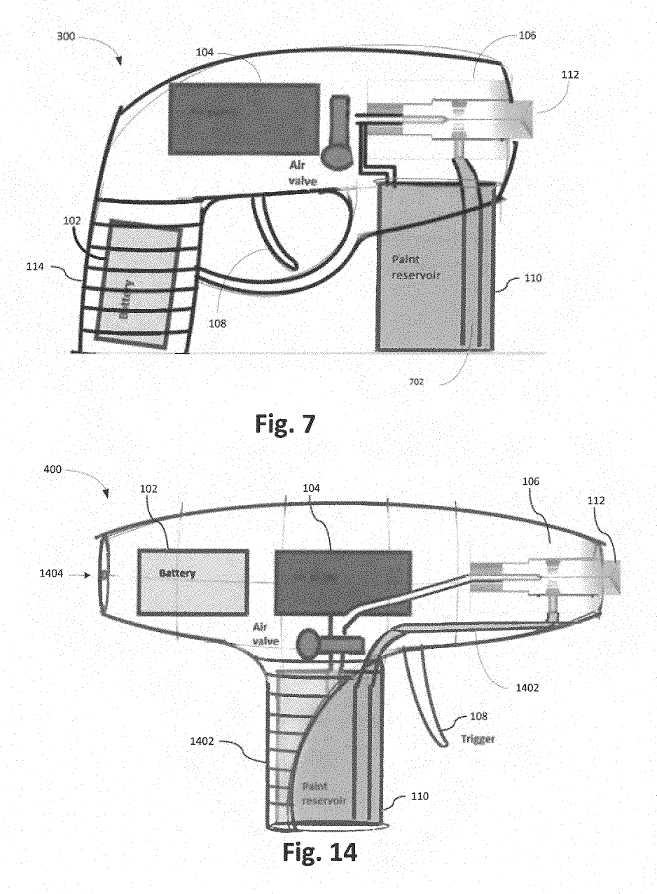

In an example embodiment, the fluid source is a disposable fluid source containing paint. A tube (see e.g., 702 in FIG. 7) couples the fluid source to the disposable tip insert 112. In an example embodiment, the fluid source is an aerosol fluid source. In particular embodiments, the fluid source is a transparent container that can allow a user to see the color of the fluid (e.g., paint).

In an example embodiment, the actuation mechanism 108 has a first setting (e.g., “ON”) and a second setting (e.g., “OFF”). The actuation mechanism can 108 be a switch, and in particular embodiments, a trigger switch. When in the first (“ON”) position, power is provided from the power source 102 to the motor and pump assembly 104 causing the motor and pump assembly 104 to provide air to the tip insert, 112 and the fluid source 110 is operable to provide fluid (e.g., paint) to the tip insert 112. The fluid from the fluid assembly is mixed with the air at the tip insert and the mixed fluid and air are dispensed from the tip insert.

In an example embodiment, the fluid does not pass through the pump assembly. Thus, the pump does not get contaminated by fluid (paint) which can allow for easily changing colors of paint during operation by changing the disposable tip insert 112 and the disposable fluid source 110.

In an example embodiment, the nozzle assembly 106 comprises a nose section. The disposable tip insert 112 is coupled with the nose section. The disposable tip insert 112 receives air from the motor and pump assembly 104 and paint from the fluid source 110. In particular embodiments, the disposable tip insert 112 comprises an air forcing cone. In some embodiments, the disposable tip insert 112 is threadably fastened to the nose section of the sprayer 300. In an alternative embodiment, pressure to the fluid source 110 is provided by the motor and pump assembly 104. This pressure will cause fluid to flow from the fluid source 110 to the tip insert 112. In an example embodiment, this may be combined with the Venturi pump as described herein or with an aerosol fluid source as described herein supra.

In an example embodiment, air is pumped into the paint reservoir 110 by the pump that causes the fluid in the paint reservoir to pass through the tube to the nozzle assembly 106. In this example embodiment, the pump is not wetted (i.e., the pump only provides air and no fluid passes through the pump). Thus, the tip insert 112 and paint reservoir 110 can be disposable. This can prevent the inadvertent mixing of colors, or contamination, of the paint being applied.

In an example embodiment, the paint reservoir 110 is clear. This can allow a user to view the color of the paint in the reservoir. This can aid the user in mixing paint to discern the color of the contents while mixing.

In an example embodiment, the sprayer 300 is hand held and weights less than 1000 grams. The approximately dimensions are less than 25 centimeters (“cm”) in length, less than 25 cm in height, and less than 10 cm in width. The paint reservoir is removable and in particular embodiments holds approximately 200 milliliter (“mL”) of fluid. In an example embodiment, the reservoir 110 is disposable. In other embodiments, the reservoir 110 is reusable. In an example embodiment, the sprayer body, handle, reservoir, and trigger mechanism are made of a durable plastic. The sprayer 300 is capable of being dropped up to 3 meters without functional damage.

In an example embodiment, the sprayer 300 is powered by a rechargeable battery pack and DC pump capable of delivering up to 25 (pounds per square inch (“psi”) and 0.5 standard cubic feet per hour (“scfh”). The sprayer 300 will be able to run continuously for up 30 minutes on a single charge. The sprayer 300 is capable of delivering up to 15 mL per minute. The sprayer 300 is capable of operating in a temperature range of 10-40° C. (Celsius).

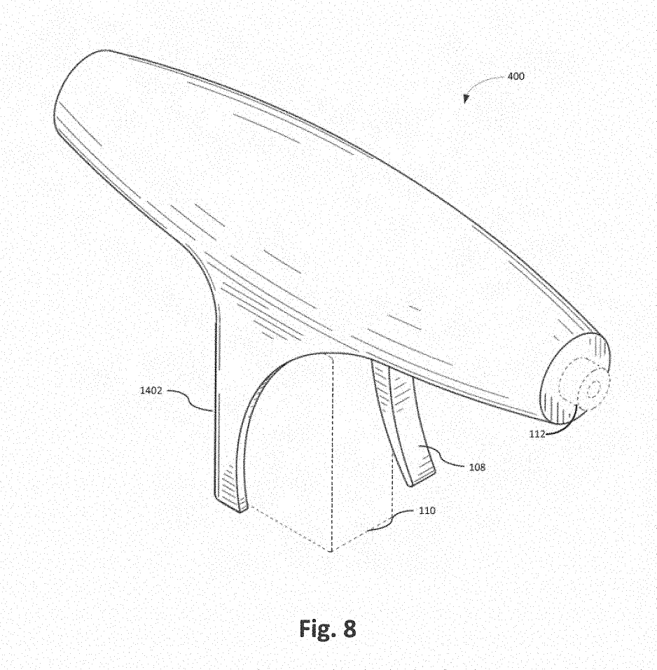

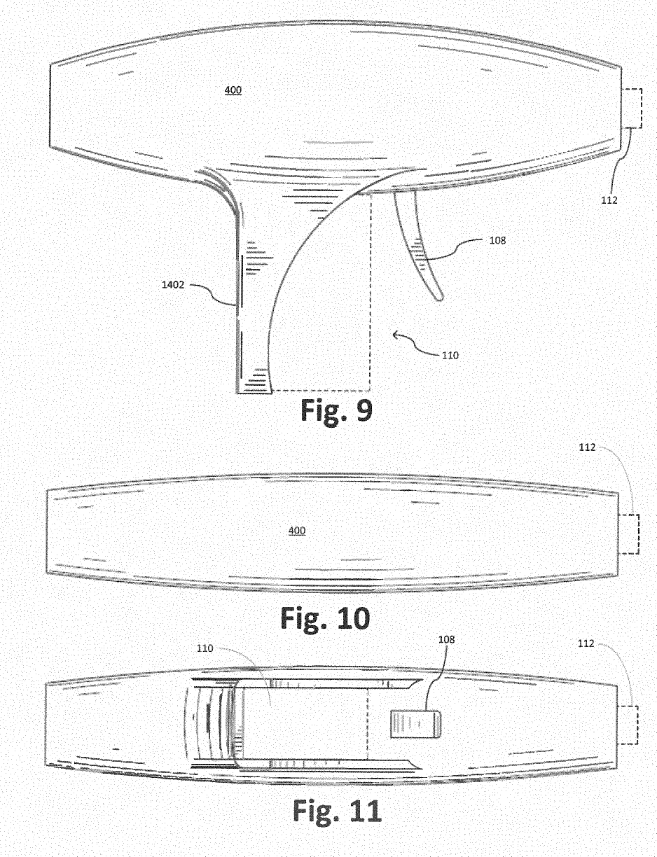

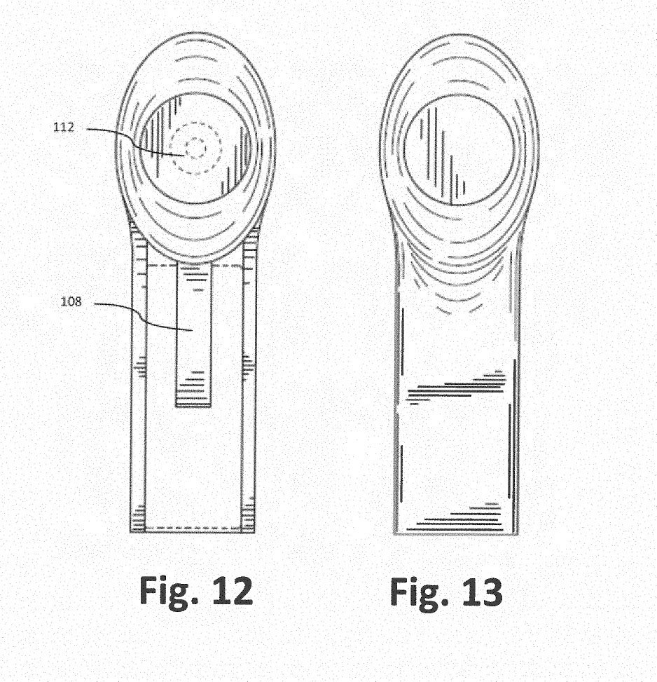

Referring to FIGS. 8-14, there is illustrated an example of a sprayer 400 in accordance with an example embodiment. The sprayer 400 comprises a power source 102, a motor and pump assembly 104, a nozzle assembly 106, an activation mechanism (trigger) 108, a fluid source (e.g., paint reservoir) 110, and a disposable tip insert 112. In the example illustrated in FIGS. 8-14, the power source (battery) 102 is located at the rear of the body of the sprayer 400, and the paint reservoir 110 is located underneath the center of the body of the sprayer 400 behind the trigger 108. The paint reservoir 110 is at least partially encircled by the grip 1402 of the sprayer 400. A charger plug 1404 is disposed at the rear of the body of the sprayer 400 and allows for the battery 102 to be recharged.

The power source 102 is coupled with the motor and pump assembly 104. The motor and pump assembly is coupled with the tip insert 112 in nozzle assembly 106. In particular embodiments, an air valve is disposed between the motor and air pump assembly 104, and fluid source 110 and the tip insert 112. The fluid source 110 and motor and pump assembly are coupled with the tip insert 112 nozzle assembly 106. In the illustrated example, the actuation mechanism (trigger) 108 is coupled with the motor and pump assembly 104 and the fluid source 110. Those skilled in the art should readily appreciate that the arrangement of the components 102, 104, 106, 108, 110, 112 for the sprayer 400 was selected merely for ease of illustration and that the components 102, 104, 106, 108, 110, 112 for the sprayer 400 may be arranged in any desirable configuration.

The power 102 source may be any suitable power source, including but not limited to a coupling for an external power source, a battery and a rechargeable battery. The power source 102 may provide any desired voltage and/or current. In an example embodiment, the power source 102 comprises a rechargeable battery pack that is capable of providing power enabling the sprayer 400 to be able to run continuously for up 30 minutes on a single charge.

In an example embodiment, the motor and pump assembly comprises a Direct Current (“DC”) motor that operates the pump. The pump is capable of delivering up to 25 (pounds per square inch (“psi”) and 0.5 standard cubic feet per hour (“scfh”).

In an example embodiment, the fluid source is a disposable fluid source containing paint. A tube (see e.g., 1402 in FIG. 4) couples the fluid source to the disposable tip insert 112. In an example embodiment, the fluid source is an aerosol fluid source. In particular embodiments, the fluid source is a transparent container that can allow a user to see the color of the fluid (e.g., paint).

In an example embodiment, the actuation mechanism 108 has a first setting (e.g., “ON”) and a second setting (e.g., “OFF”). The actuation mechanism can 108 be a switch, and in particular embodiments, a trigger switch. When in the first (“ON”) position, power is provided from the power source 102 to the motor and pump assembly 104 causing the motor and pump assembly 104 to provide air to the tip insert, 112 and the fluid source 110 is operable to provide fluid (e.g., paint) to the tip insert 112. The fluid from the fluid assembly is mixed with the air at the tip insert and the mixed fluid and air are dispensed from the tip insert.

In an example embodiment, the fluid does not pass through the pump assembly. Thus, the pump does not get contaminated by fluid (paint) which can allow for easily changing colors of paint during operation by changing the disposable tip insert 112 and the disposable fluid source 110.

In an example embodiment, the nozzle assembly 106 comprises a nose section. The disposable tip insert 112 is coupled with the nose section. The disposable tip insert 112 receives air from the motor and pump assembly 104 and paint from the fluid source 110. In particular embodiments, the disposable tip insert 112 comprises an air forcing cone. In some embodiments, the disposable tip insert 112 is threadably fastened to the nose section of the sprayer 300. In an alternative embodiment, pressure to the fluid source 110 is provided by the motor and pump assembly 104. This pressure will cause fluid to flow from the fluid source 110 to the tip insert 112. In an example embodiment, this may be combined with the Venturi pump as described herein or with an aerosol fluid source as described herein supra.

In an example embodiment, air is pumped into the paint reservoir 110 by the pump that causes the fluid in the paint reservoir to pass through the tube to the nozzle assembly 106. In this example embodiment, the pump is not wetted (i.e., the pump only provides air and no fluid passes through the pump). Thus, the tip insert 112 and paint reservoir 110 can be disposable. This can prevent the inadvertent mixing of colors, or contamination, of the paint being applied.

In an example embodiment, the paint reservoir 110 is clear. This can allow a user to view the color of the paint in the reservoir. This can aid the user in mixing paint to discern the color of the contents while mixing.

In an example embodiment, the sprayer 400 is hand held and weights less than 1,000 grams. The approximately dimensions are less than 25 centimeters (“cm”) in length, less than 25 cm in height, and less than 10 cm in width. The paint reservoir is removable and in particular embodiments holds approximately 200 milliliter (“mL”) of fluid. In an example embodiment, the reservoir 110 is disposable. In other embodiments, the reservoir 110 is reusable. In an example embodiment, the sprayer body, handle, reservoir, and trigger mechanism are made of a durable plastic. The sprayer 400 is capable of being dropped up to 3 meters without functional damage.

In an example embodiment, the sprayer 400 is powered by a rechargeable battery pack and DC pump capable of delivering up to 25 (pounds per square inch (“psi”) and 0.5 standard cubic feet per hour (“scfh”). The sprayer 400 will be able to run continuously for up 30 minutes on a single charge. The sprayer 400 is capable of delivering up to 15 mL per minute. The sprayer 400 is capable of operating in a temperature range of 10-40° C. (Celsius).

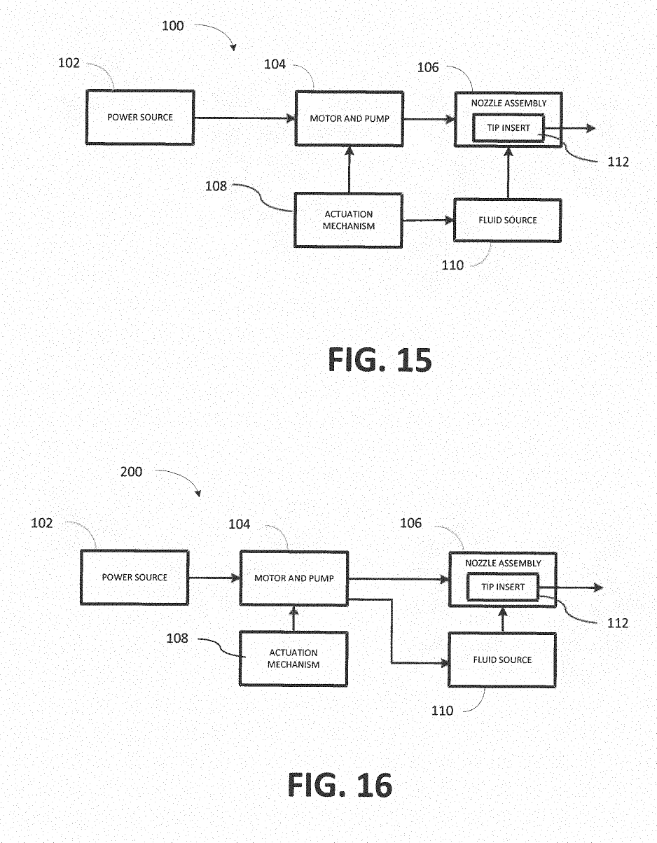

Referring to FIG. 15, there is illustrated a block diagram illustrating an example of a sprayer 100 in accordance with an example embodiment. The sprayer comprises a power source 102, a motor and pump assembly 104, a nozzle assembly 106, an activation mechanism 108, a fluid source 110, and a disposable tip insert 112.

The power source 102 is coupled with the motor and pump assembly 104. The motor and pump assembly is coupled with the tip insert 112 in nozzle assembly 106. The fluid source 110 is and motor and pump assembly are coupled with the tip insert 112 nozzle assembly 106. In the illustrated example, the actuation mechanism is coupled with the motor and pump assembly 104 and the fluid source 110. Those skilled in the art should readily appreciate that the arrangement of the components 102, 104, 106, 108, 110, 112 for the sprayer 100 was selected merely for ease of illustration and that the components 102, 104, 106, 108, 110, 112 for the sprayer 100 may be arranged in any desirable configuration.

The power 102 source may be any suitable power source, including but not limited to a coupling for an external power source, a battery and a rechargeable battery. The power source 102 may provide any desired voltage and/or current. In an example embodiment, the power source 102 comprises a rechargeable battery pack that is capable of providing power enabling the sprayer 100 to be able to run continuously for up 30 minutes on a single charge.

In an example embodiment, the motor and pump assembly comprises a Direct Current (“DC”) motor that operates the pump. The pump is capable of delivering up to 25 (pounds per square inch (“psi”) and 0.5 standard cubic feet per minute (“scfm”).

In an example embodiment, the fluid source is a disposable fluid source containing paint. A tube (not shown, see e.g., FIG. 4) coupled the fluid source to the disposable tip insert 112. In an example embodiment, the fluid source is an aerosol fluid source. In particular embodiments, the fluid source is a transparent container that can allow a user to see the color of the fluid (e.g., paint).

In an example embodiment, the actuation mechanism 108 has a first setting (e.g., “ON”) and a second setting (e.g., “OFF”). The actuation mechanism can 108 be a switch, and in particular embodiments, a trigger switch. When in the first (“ON”) position, power is provided from the power source 102 to the motor and pump assembly 104 causing the motor and pump assembly 104 to provide air to the tip insert, 112 and the fluid source 110 is operable to provide fluid (e.g., paint) to the tip insert 112. The fluid from the fluid assembly is mixed with the air at the tip insert and the mixed fluid and air are dispensed from the tip insert.

In an example embodiment, the fluid does not pass through the pump assembly. Thus, the pump does not get contaminated by fluid (paint) which can allow for easily changing colors of paint during operation by changing the disposable tip insert 112 and the disposable fluid source 110.

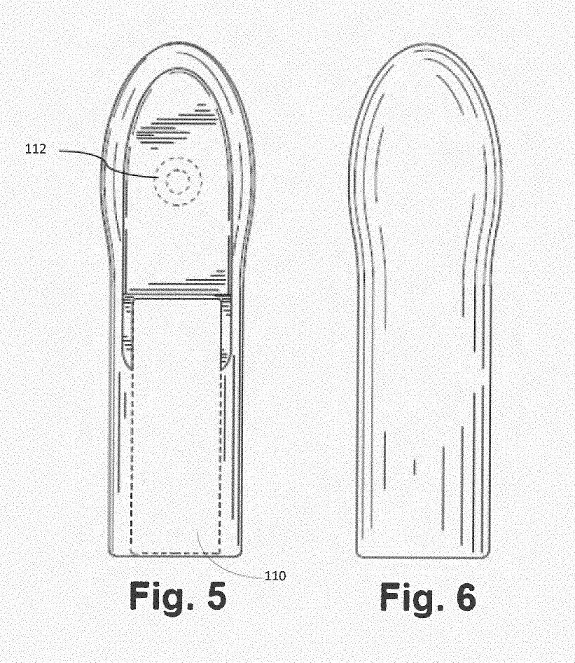

In an example embodiment, the nozzle assembly 106 comprises a nose section (not shown, see, e.g., FIGS. 4 and 5). The disposable tip insert 112 is coupled with the nose section. The disposable tip insert 112 receives air from the motor and pump assembly 104 and paint from the fluid source 110. In particular embodiments, (see, e.g., FIG. 5), the disposable tip insert comprises an air forcing cone (not shown, see, e.g., FIG. 5). In some embodiments, the disposable tip insert 112 is threadably fastened to the nose section of the sprayer 100. In an example embodiment, at least one O-ring (not shown, see, e.g., FIG. 5) is employed to provide a seal between the tip insert 112 and the nose section.

In an example embodiment, the pump in the motor and pump assembly 104 is a Venturi pump. As air moves through a restricted nozzle (e.g., FIG. 5 where after air forcing cone where paint enters the tip), a vacuum is created that draws paint from the fluid source 102. The resulting air/liquid mix atomizes and is dispensed out of the paint spray exit.

FIG. 16 illustrates an alternative embodiment where the pressure to the fluid source 110 is provided by the motor and pump assembly 104. This pressure will cause fluid to flow from the fluid source 110 to the tip insert 112. In an example embodiment, this may be combined with the Venturi pump as described in the preceding paragraph or with an aerosol fluid source as described herein supra.

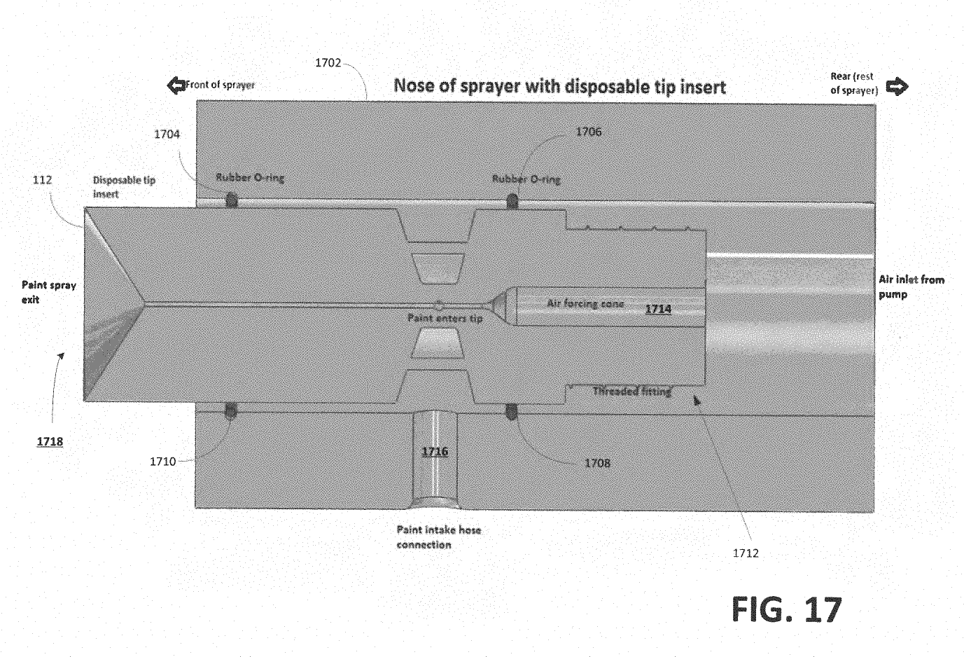

FIG. 17 illustrates an example of the nose 1702 of the sprayer coupled with a disposable tip insert 112, and also illustrates an example of the internal components of the disposable tip. The tip insert 112 is mounted on the nose 1702 of the sprayer and in the illustrated example employs four rubber O-rings 1704, 1706, 1708, 1710 are employed to seal the tip insert. In the illustrated example, a threaded fastener 1712 is employed to couple the tip insert to the nose of the sprayer. Air from the inlet pump is provided to the air forcing cone 1714. Fluid (e.g., paint in this example) provided by the paint intake hose connection 1716 enters the tip 112 at the location indicated in FIG. 17. The spray exits the disposable insert at the location 1718 indicated in FIG. 17.

In an example embodiment, air is pumped into the paint reservoir by the pump that causes the fluid in the paint reservoir to pass through the tube to the sprayer tip assembly. In this example embodiment, the pump is not wetted (i.e., the pump only provides air and no fluid passes through the pump). Thus, the nozzle and paint reservoir can be disposable. This can prevent the inadvertent mixing of colors, or contamination, of the paint being applied.

In an example embodiment, the paint reservoir is clear. This can allow a user to view the color of the paint in the reservoir. This can aid the user in mixing paint to discern the color of the contents while mixing.

In an example embodiment, the sprayer is hand held and weights less than 1,000. The approximately dimensions are less than 25 centimeters (“cm”) in length, less than 25 cm in height, and less than 10 cm in width. The paint reservoir is removable and in particular embodiments holds approximately 200 milliliter (“mL”) of fluid. In an example embodiment, the reservoir is disposable. In other embodiments, the reservoir is reusable. In an example embodiment, the sprayer body, handle, reservoir, and trigger mechanism are made of a durable plastic. The sprayer is capable of being dropped up to 3 meters without functional damage.

In an example embodiment, the sprayer is powered by a rechargeable battery pack and DC pump capable of delivering up to 25 (pounds per square inch (“psi”) and 0.5 standard cubic feet per hour (“scfh”). The sprayer will be able to run continuously for up 30 minutes on a single charge. The sprayer is capable of delivering up to 15 mL per minute. The sprayer is capable of operating in a temperature range of 10-40° C. (Celsius).

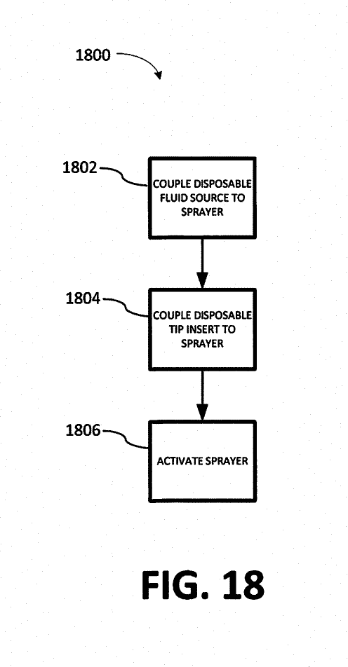

In view of the foregoing structural and functional features described above, a methodology 1800 in accordance with an example embodiment will be better appreciated with reference to FIG. 18. While, for purposes of simplicity of explanation, the methodology 1800 of FIG. 18 is shown and described as executing serially, it is to be understood and appreciated that the example embodiment is not limited by the illustrated order, as some aspects could occur in different orders and/or concurrently with other aspects from that shown and described herein. Moreover, not all illustrated features may be required to implement a methodology in accordance with an aspect of an example embodiment. The methodology 1800 is for operating a sprayer, the sprayer comprising a rechargeable power source coupled with a motor and pump assembly, the motor and pump assembly coupled with an actuation mechanism and a nozzle assembly, the nozzle assembly located at a nose section of the sprayer.

At 1804, a disposable fluid source is coupled with the sprayer. Any suitable technique may be employed to couple the disposable fluid source with the sprayer. For example, the fluid source may be threadably fastened to the sprayer. As another example, latches may be employed to couple the disposable fluid source to the sprayer. In yet another example embodiment, a compression fitting may be employed to couple the disposable fluid source to the sprayer. As those skilled in the art can readily appreciate, a proprietary coupling may also be employed.

At 1804, fastening a disposable tip assembly is coupled with the nozzle assembly. Any suitable technique may be employed for coupling the disposable tip assembly to the nozzle assembly. For example, the disposable tip assembly may threadably engage the nozzle assembly. In an example embodiment, a tube may be employed to couple the disposable tip assembly with the disposable fluid source.

At 1806, the sprayer is activated by employing the actuation mechanism. Activating the actuation mechanism causes fluid to flow from the fluid source to the disposable tip assembly, the motor and pump assembly to provide air to the disposable tip assembly, and a mixture of the air and the fluid to be dispensed from the disposable tip assembly. In an example embodiment, fluid from the fluid source flows to the nozzle assembly without passing through the motor and pump assembly.

Described above are example embodiments. It is, of course, not possible to describe every conceivable combination of components or methodologies for purposes of describing the example embodiments, but one of ordinary skill in the art will recognize that many further combinations and permutations of the example embodiments are possible. Accordingly, it is intended to embrace all such alterations, modifications and variations that fall within the spirit and scope of any claims filed in applications claiming priority hereto interpreted in accordance with the breadth to which they are fairly, legally and equitably entitled.

1. An apparatus, comprising:
a rechargeable power source;
a motor and pump assembly coupled with the rechargeable battery;
a fluid source;
a nozzle assembly coupled with the motor and pump assembly and the fluid source; and
an actuation mechanism having an first setting and a second setting coupled with the motor and pump assembly;
wherein when the actuation mechanism is at the first setting, air is pumped by the motor and pump assembly to the nozzle assembly and fluid is provided by the fluid source to the nozzle assembly without passing through the motor and pump assembly, the fluid is mixed with the air at the nozzle assembly; and
wherein the mixed air and fluid are dispensed by the assembly.

2. The apparatus set forth in claim 1, wherein the rechargeable power source holds sufficient charge to run the motor and pump assembly for thirty minutes continuously on a single charge.

3. The apparatus set forth in claim 2, wherein the rechargeable power source is a battery.

4. The apparatus set forth in claim 1, wherein the pump is a direct current pump capable of delivering up to 25 pounds per square inch and 0.5 standard cubic feet per hour.

5. The sprayer set forth in claim 1, wherein the fluid source is an aerosol fluid source.

6. The apparatus set forth in claim 5, wherein the fluid source comprises paint.

7. The apparatus set forth in claim 6, wherein the nozzle assembly comprises:
a nose section; and
a disposable tip insert coupled with the nose section, the tip insert receives air from the motor and pump assembly and paint from the fluid source.

8. the apparatus set forth in claim 7, wherein the disposable tip insert comprises an air forcing cone.

9. The apparatus according to claim 8, wherein disposable the tip insert is threadably fastened to the nose section.

10. The apparatus according to claim 9, further comprising an O-ring, wherein the O-ring provides a seal between the tip assembly and the nose section.

11. The apparatus according to claim 7, wherein the air from the motor creates a vacuum that draws the paint from the fluid source.

12. The apparatus according to claim 1, wherein the actuation mechanism is a trigger switch.

13. The apparatus according to claim 1, wherein the motor and pump assembly provides air to the fluid source to pressurize the fluid source.

14. A method of operating a sprayer, the sprayer comprising a rechargeable power source coupled with a motor and pump assembly, the motor and pump assembly coupled with an actuation mechanism and a nozzle assembly, the nozzle assembly located at a nose section of the sprayer, the method comprising:
fastening a disposable tip assembly to the nozzle assembly;
coupling a disposable fluid source to the nozzle assembly; and
activating the actuation mechanism, wherein activating the actuation mechanism causes fluid to flow from the fluid source to the disposable tip assembly, the motor and pump assembly to provide air to the disposable tip assembly, and a mixture of the air and the fluid to be dispensed from the disposable tip assembly;
wherein fluid from the fluid source flows to the nozzle assembly without passing through the motor and pump assembly.

15. The method set forth in claim 14, wherein fastening the disposable tip assembly to the nozzle assembly comprises threadably engaging the disposable tip assembly to the nozzle assembly.

16. The method set forth in claim 14, further comprising coupling the disposable fluid source to the disposable tip insert with a tube.

17. The method set forth in claim 14, wherein the fluid from the fluid dispenser flows through the tube to the disposable tip insert without passing through the pump.

18. The method set forth in claim 14, wherein the fluid source is an aerosol.

19. A kit, comprising:
a sprayer assembly containing a rechargeable power source, a motor and pump assembly coupled with the rechargeable battery, a nozzle assembly coupled with the motor and pump assembly and the fluid source, and a trigger switch coupled with the motor and pump assembly;
a disposable fluid container configured to be coupled with the sprayer assembly;
a disposable tip insert configured to be threadably fastened to the nozzle assembly; and
a tube coupling the disposable fluid container with the disposable tip insert.
